(19) United States
(12) Patent Application Publication
(10) Pub. No.: US 2026/0313227 A1
(43) Pub. Date: Oct. 8, 2026

(54) IMAGING APPARATUS, METHOD FOR CONTROLLING IMAGING APPARATUS, AND NON-TRANSITORY COMPUTER-READABLE STORAGE MEDIUM

(71) Applicant: CANON KABUSHIKI KAISHA, Tokyo (JP)

(72) Inventor: Tatsuya Wada, Kanagawa (JP)

(21) Appl. No.: 19/577,720

(22) Filed: Mar. 25, 2026

(30) Foreign Application Priority Data
Apr. 7, 2025 (JP) 2025-063360

(51) Int. Cl. H04N 23/661; H04N 23/667

(52) U.S. Cl. CPC H04N 23/661; H04N 23/667

(57) ABSTRACT

An imaging apparatus, comprising: a wireless communication unit that communicates wirelessly with an external device; and a switching unit that switches a controller that controls the wireless communication unit between a first controller and a second controller different from the first controller, wherein the switching unit performs switching so as to connect the wireless communication unit and the first controller in a first mode, and to connect the wireless communication unit and the second controller in a second mode in which a processing load is larger than in the first mode.

### BACKGROUND

### Field of the Technology

The present disclosure relates to an imaging apparatus, a method for controlling an imaging apparatus, and a non-transitory computer-readable storage medium.

### Description of the Related Art

In imaging apparatuses, a wireless communication function for communication with an external device is generally installed by mounting a wireless module. Some wireless modules support a plurality of wireless communication standards with a single module. For example, it is possible to use different standards such as using a wireless LAN (Local Area Network) compliant with the IEEE 802.11 standard in cases where high-speed communication is required, and using Bluetooth (registered trademark) Low Energy (hereinafter BLE), which has low power consumption, in cases where low-speed communication is sufficient.

In addition, imaging apparatuses are generally divided into a mode for shooting still images and a mode for shooting movies. Although the situation changes depending on resolution, frame rate, and the like, in cases where functions such as internal recording of video and transmission of streaming video are used simultaneously, the processing load of a microcontroller that controls the imaging apparatus may become larger in the movie mode than in the still image mode. In wireless communication as well, the processing load of the microcontroller tends to become larger as the communication speed increases, and depending on the performance of the microcontroller, when the movie mode and wireless LAN communication are used simultaneously, the operation may become unstable and it may become necessary to impose functional restrictions.

Japanese Patent Application Laid-Open No. 2014-30077 discloses achieving reduction in power consumption by switching processing of the entire apparatus to a low-power controller during a sleep mode.

However, in the technology of Japanese Patent Application Laid-Open No. 2014-30077, there is a problem that it is difficult to reduce the processing load of the controller when the controller of an apparatus capable of operating in various operation modes such as a still image mode and a movie mode is operating in an operation mode with a high processing load (for example, the movie mode).

### SUMMARY

The present disclosure was made in view of the above-described problem, and provides a technique for reducing the processing load of a controller in an operation mode where the processing load of the controller is high.

According to one aspect of the present disclosure, there is provided an imaging apparatus, comprising: a wireless communication unit that communicates wirelessly with an external device; and a switching unit that switches a controller that controls the wireless communication unit between a first controller and a second controller different from the first controller, wherein the switching unit performs switching so as to connect the wireless communication unit and the first controller in a first mode, and to connect the wireless communication unit and the second controller in a second mode in which a processing load is larger than in the first mode.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram showing a hardware configuration of an imaging apparatus according to one embodiment.

FIG. 2 is a diagram showing features of communication standards usable in the imaging apparatus according to one embodiment.

FIG. 3 is a diagram showing a controller of a wireless module for each combination of an operation mode and a wireless communication standard of the imaging apparatus according to one embodiment.

FIG. 4 is a flowchart showing a procedure of processing performed by the imaging apparatus according to one embodiment.

FIG. 5 is a flowchart showing a procedure of other processing performed by the imaging apparatus according to one embodiment.

### DESCRIPTION OF THE EMBODIMENTS

Embodiments will be described in detail below with reference to the attached drawings. Note that the following embodiments do not limit the scope of the claims. Although multiple features are described in the embodiments, not all of these multiple features are necessarily required, and the multiple features may be arbitrarily combined. Furthermore, in the attached drawings, the same or similar configurations are assigned the same reference numerals, and redundant description will be omitted.

### Hardware Configuration of Imaging Apparatus

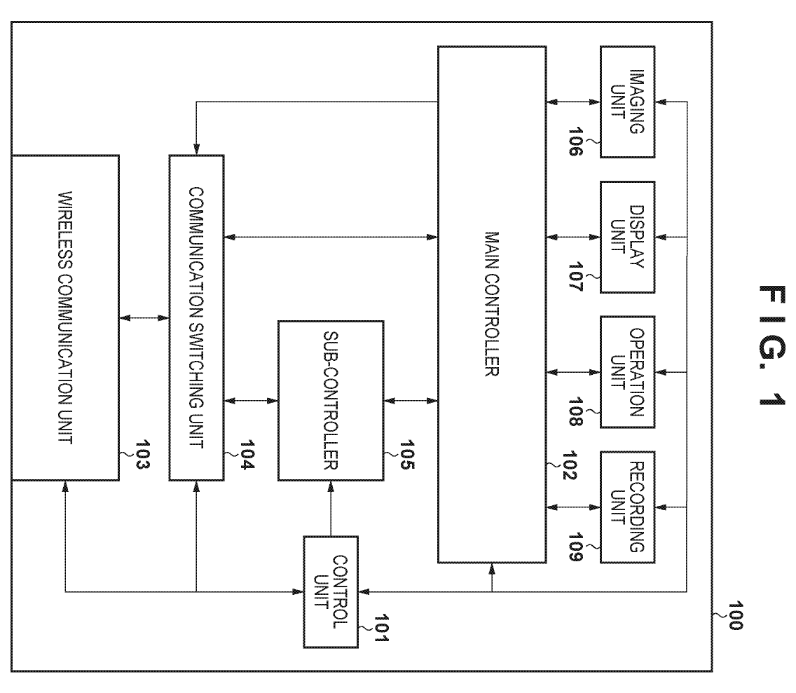

FIG. 1 is a block diagram showing a hardware configuration example of an imaging apparatus 100 according to the present embodiment. The imaging apparatus 100 includes a control unit 101, a main controller 102, a wireless communication unit 103, a communication switching unit 104, a sub-controller 105, an imaging unit 106, a display unit 107, an operation unit 108, and a recording unit 109.

The control unit 101 is configured to include a device such as a microcontroller unit (MCU) and a power supply circuit. The control unit 101 performs power supply control and power supply for each part of the imaging apparatus 100 including the main controller 102 and the wireless communication unit 103, and performs control of operation modes of the imaging apparatus 100. Further, the control unit 101 performs processing such as detecting an input to the operation unit 108 from a user and notifying the main controller 102 of the input. Further, the control unit 101 can also function as a determination unit that performs various determination processes.

The main controller 102 is configured with devices such as an ASIC specialized for imaging processing, an SDRAM as a working memory, and a ROM (Read Only Memory) that stores programs for the main controller 102. Here, ASIC is an abbreviation for Application Specific Integrated Circuit. SDRAM is an abbreviation for Synchronous Dynamic Random Access Memory. ROM is an abbreviation for Read Only Memory.

The main controller 102 performs main data processing of the imaging apparatus 100. For example, the main controller 102 performs control of imaging processing of the imaging unit 106, conversion of acquired still image/movie data, and transmission of data to be displayed on the display unit 107. Further, the main controller 102 performs control of a touch panel or the like of the operation unit 108 that the main controller 102 directly communicates with and controls, and UI (User Interface) control according to input values of buttons, dials, or the like input via the control unit 101.

Further, the main controller 102 performs media control such as writing and reading of still image/movie data to and from a built-in memory or an external medium, which is the recording unit 109. Further, in wireless communication control, a configuration can be adopted in which the wireless communication unit 103 and the main controller 102 are connected via the communication switching unit 104. Alternatively, it is also possible to adopt a configuration in which the wireless communication unit 103 and the sub-controller 105 are connected via the communication switching unit 104, and the sub-controller 105 performs a part of the wireless communication control.

The wireless communication unit 103 is configured with a device such as a wireless LAN module that performs communication with an external device by wireless communication. In the present embodiment, a combo module having communication functions of wireless LAN and BLE will be described as an example. The wireless communication unit 103 is connectable to a communication bus of either the main controller 102 or the sub-controller 105 via the communication switching unit 104. The wireless communication unit 103 performs communication such as file transfer with a partner device such as a wirelessly connected smartphone or computer, by communication control from the connected controller.

The communication switching unit 104 is configured with a device such as a multiplexer. The communication switching unit 104 receives a selection signal from the main controller 102 and switches a connection destination of the communication bus of the wireless communication unit 103 to either the main controller 102 or the sub-controller 105.

The sub-controller 105 is configured with devices such as a general-purpose microcontroller for communication processing, an SDRAM as a working memory, and a ROM that stores programs for the sub-controller 105. When the main controller 102 directly controls the wireless communication unit 103, or when the wireless communication function is not used, the control unit 101 maintains the sub-controller 105 in a power-off state. On the other hand, the sub-controller 105 is powered on by the control unit 101 when performing wireless communication control on behalf of the main controller 102.

Wireless communication control indicates performing transmission/reception of commands and reception of events while communicating with the wireless communication unit 103 by a driver of each controller, or notifying an upper layer application as necessary. In response to this wireless communication control, the wireless communication unit 103 performs generation and transmission of wireless frames, receives wireless frames from a wirelessly connected partner device, or performs command responses and event notifications to the driver.

Further, the sub-controller 105 in the present embodiment also performs control regarding applications in addition to the wireless communication control. The sub-controller 105 also performs application processing such as HTTP and FTP on behalf of the main controller 102, depending on the wireless LAN function to be used. Here, HTTP is an abbreviation for Hypertext Transfer Protocol, and FTP is an abbreviation for File Transfer Protocol.

Further, when the sub-controller 105 performs wireless communication control, the sub-controller 105 is connected to the main controller 102 by a dedicated bus, and performs exchange of data transmitted and received by wireless communication and notification of events acquired from the wireless communication unit 103.

The imaging unit 106 is configured with, for example, an optical lens unit, a drive system that controls an aperture, zoom, focus, and the like, and an imaging element for converting light (image) introduced through the optical lens unit into an electrical image signal. By being controlled by the main controller 102, the imaging unit 106 converts subject light formed into an image by a lens included in the imaging unit 106 into an electrical signal by the imaging element, performs noise reduction processing and the like, and outputs digital data as still image/movie data.

The display unit 107 performs view finder and a liquid crystal screen display at the time of shooting, display of shot still image/movie data, character display for interactive operation, and the like. Note that the display unit 107 does not necessarily need to be built into the imaging apparatus 100. The imaging apparatus 100 may be configured to be connectable to an internal or external display unit, and it is sufficient if it has at least a display control function for controlling display of a display unit.

The operation unit 108 is configured with devices such as buttons, dials, and a touch panel for a user to control the imaging apparatus 100. The control unit 101 or the main controller 102 performs input control at the operation unit 108 according to characteristics, interfaces, and the like of the devices. As the operation mode of the imaging apparatus 100, any one mode of power off, a still image mode, and a movie mode is selected according to a state of a three-position switch included in the operation unit 108. Note that this switch is not limited to a three-position switch, and may be realized by combining a plurality of switches such as a two-position switch for selecting an operation mode and a push switch for switching power on/off.

The recording unit 109 is configured with a device such as a built-in non-volatile memory, an SD (Secure Digital) card connected via a media slot, or an external SSD (Solid State Drive). The recording unit 109 performs writing and reading of shot still image/movie data by media control from the main controller 102.

### Supported Communication Standards of Imaging Apparatus

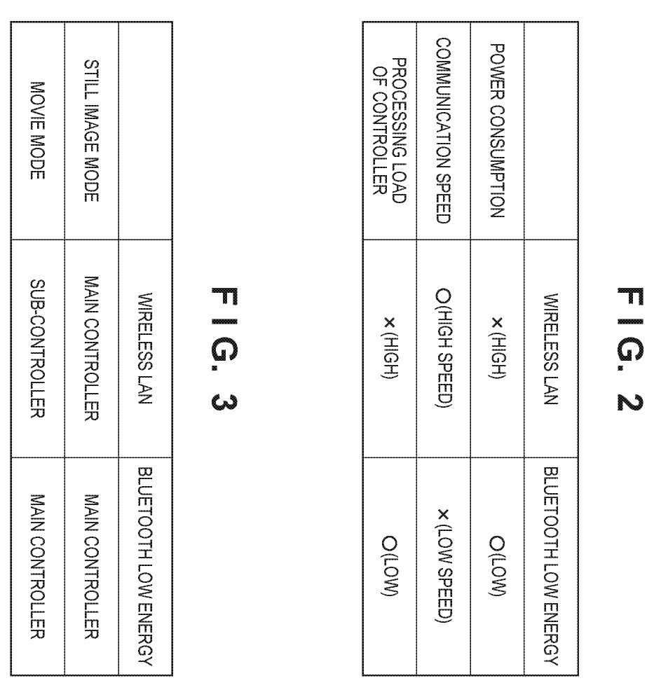

The wireless communication unit 103 in the present embodiment is a combo module supporting wireless LAN and BLE as described above, and FIG. 2 shows features of these communication systems. In a wireless LAN in which relatively high-speed communication is possible, it is possible to transmit and receive more data, but power consumption required for wireless communication in the wireless communication unit 103 becomes high, and a processing load required for wireless communication control in the main controller 102 also becomes large. On the other hand, in BLE in which relatively low-speed communication is possible, power consumption required for wireless communication in the wireless communication unit 103 is low, and the processing load required for wireless communication control in the main controller 102 is also relatively small.

### Controller of Wireless Communication Unit According to Each Operation Mode of Imaging Apparatus

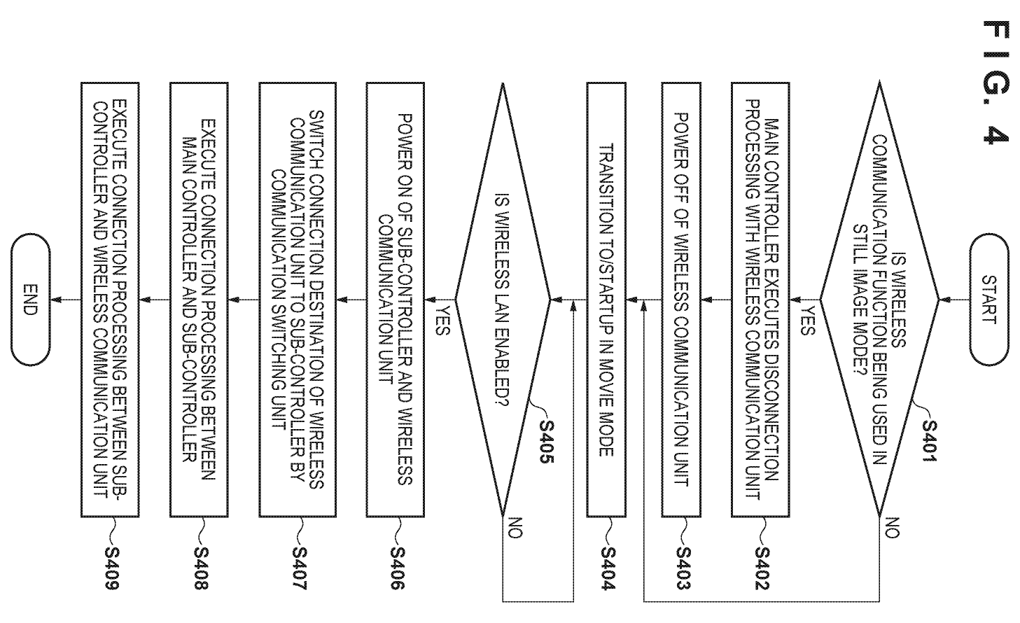

Taking these into consideration, in the present embodiment, as shown in FIG. 3, in the movie mode where the imaging processing load of the main controller 102 becomes high, when a wireless LAN having a large processing load on the controller is used for wireless communication control, the sub-controller 105 performs control of the wireless communication unit 103.

Even in the movie mode where the imaging processing load of the main controller 102 becomes large, when BLE having a small processing load on the controller is used for wireless communication control, the main controller 102 performs control of the wireless communication unit 103.

In the still image mode in which the imaging processing load of the main controller 102 becomes small, the main controller 102 performs control of the wireless communication unit 103 when using a wireless LAN. Further, in the still image mode in which the imaging processing load of the main controller 102 becomes small, the main controller 102 performs control of the wireless communication unit 103 when using BLE.

Note that in a case where BLE having a small processing load on the controller is used for wireless communication control, the sub-controller 105 may perform the wireless communication control, similarly to a case where wireless LAN is used, in accordance with the state of the processing load in the movie mode, where the imaging processing load is high.

### Processing

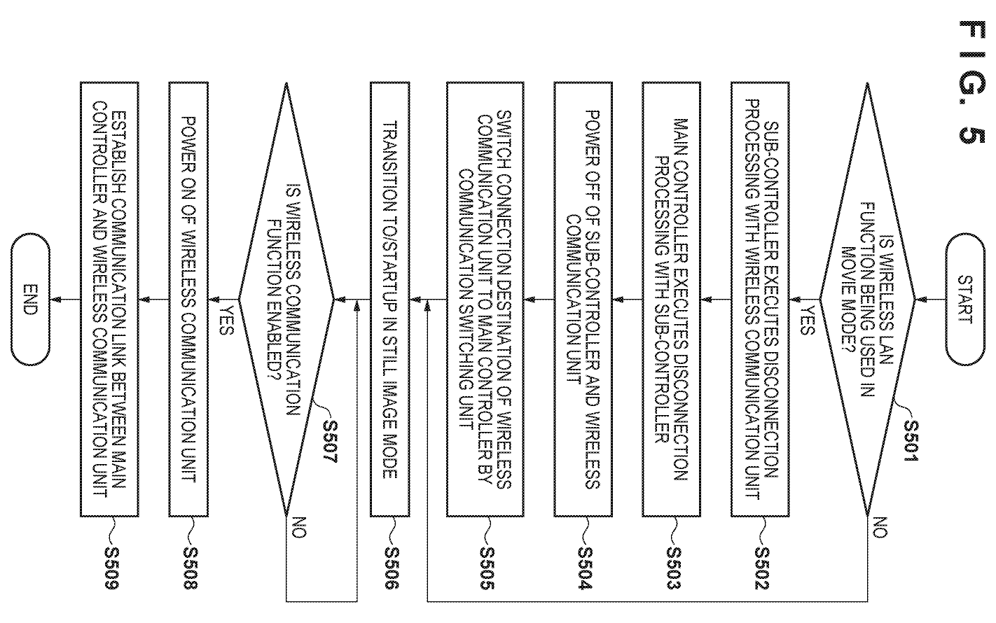

Next, a procedure of processing performed by the imaging apparatus according to the present embodiment will be described with reference to the flowchart of FIG. 4. The flowchart shown in FIG. 4 shows a control flow in a case where an operation to start the imaging apparatus 100 in the movie mode while the power is off is detected, or in a case where an operation to switch the imaging apparatus 100 operating in the still image mode to the movie mode is detected. In other words, this is processing in a case where the imaging apparatus 100 is operating in the still image mode, or in a case where the imaging apparatus 100 is started in the movie mode while the power is in an off state.

In step S401, the control unit 101 checks an operation state of the imaging apparatus 100, and determines whether or not a wireless communication function (wireless LAN function or BLE function) is being used in the still image mode. If the control unit 101 determines that the wireless communication function is being used in the still image mode, the process proceeds to step S402. On the other hand, if the control unit 101 determines that the wireless communication function is not being used in the still image mode, the process proceeds to step S404.

For example, when the control unit 101 detects an operation to start the imaging apparatus 100 in the movie mode while the power is off, it is not "currently using the wireless communication function in the still image mode," and therefore the process proceeds to step S404. Further, when the control unit 101 detects an operation for switching the imaging apparatus 100 operating in the still image mode to the movie mode, since it is currently in the still image mode, the control unit 101 determines whether or not the wireless communication function is being used. If the control unit 101 determines that the wireless communication function is not being used, the process proceeds to step S404. On the other hand, if the control unit 101 determines that the wireless communication function is being used, it is the case of "currently using the wireless communication function in the still image mode," and therefore the process proceeds to step S402, and processing for ending the wireless communication function is performed.

In step S402, the main controller 102 controls the wireless communication unit 103 to execute disconnection processing with a device connected using wireless communication, and stops the wireless communication. Thereafter, the main controller 102 disconnects communication between the main controller 102 and the wireless communication unit 103. The processing in step S402 is processing for ending the wireless communication function in preparation for transition to the movie mode.

In step S403, the control unit 101 controls a power supply circuit and turns off the power of the wireless communication unit 103.

In step S404, the control unit 101 causes the operation mode of the main controller 102 to transition to the movie mode, or starts the main controller 102 in the movie mode. When the main controller 102 transitions to the movie mode / is started in the movie mode, the control unit 101 changes an operation state of each part as necessary. For example, the control unit 101 changes a data format acquired from the imaging unit 106 or changes a UI or a video data format to be displayed on the display unit 107 as necessary.

In step S405, the control unit 101 determines whether or not a wireless LAN function in the movie mode is enabled. If the control unit 101 determines that the wireless LAN function is enabled, the process proceeds to step S406. On the other hand, if the control unit 101 determines that the wireless LAN function is not enabled, the process returns to step S405 and re-determination is performed.

In step S406, the control unit 101 controls the power supply circuit and turns on the power of the sub-controller 105 and the wireless communication unit 103.

In step S407, the main controller 102 controls the communication switching unit 104 and performs switching processing so that the wireless communication unit 103 and the sub-controller 105 are connected. At this time, the main controller 102 and the wireless communication unit 103 are in a disconnected state.

In step S408, the control unit 101 executes connection processing between the main controller 102 and the sub-controller 105, and starts communication between the main controller 102 and the sub-controller 105.

In step S409, the control unit 101 executes connection processing between the sub-controller 105 and the wireless communication unit 103. This enables wireless communication control by the sub-controller 105, and thereafter, connection with a partner device is performed by a method defined by the wireless LAN, and the wireless LAN function can be used. The above is the processing of FIG. 4.

Next, a procedure of other processing performed by the imaging apparatus according to the present embodiment will be described with reference to the flowchart of FIG. 5. The flowchart shown in FIG. 5 shows a control flow in a case where the imaging apparatus 100 operating in the movie mode detects an operation for switching to the still image mode, or in a case where the imaging apparatus 100 while the power is off detects an operation for starting in the still image mode. In other words, this is processing in a case where the imaging apparatus 100 is operating in the movie mode, or in a case where the imaging apparatus 100 is started in the still image mode while the power is in an off state.

In step S501, the control unit 101 checks the operation state of the imaging apparatus 100, and determines whether or not the wireless LAN function is being used in the movie mode. If the control unit 101 determines that the wireless LAN function is being used in the movie mode, the process proceeds to step S502. On the other hand, if the control unit 101 determines that the wireless LAN function is not being used in the movie mode, the process proceeds to step S506.

For example, when the control unit 101 detects an operation for starting the imaging apparatus 100 in the still image mode while the power is off, it is not the case of "currently using the wireless LAN function in the movie mode," and therefore the process proceeds to step S506. Further, when the control unit 101 detects an operation for switching the imaging apparatus 100 operating in the movie mode to the still image mode, since the imaging apparatus 100 is operating in the movie mode, the control unit 101 determines whether or not the wireless LAN function is being used. If the control unit 101 determines that the wireless LAN function is not being used, similarly, the process proceeds to step S506. On the other hand, if the control unit 101 determines that the wireless LAN function is being used, the process proceeds to step S502, and processing for ending the wireless LAN function is performed.

In step S502, the sub-controller 105 controls the wireless communication unit 103 to execute disconnection processing with a device connected by wireless communication, and stops the wireless communication. Thereafter, the sub-controller 105 disconnects communication between the sub-controller 105 and the wireless communication unit 103.

In step S503, the main controller 102 performs disconnection processing with the sub-controller 105, and disconnects communication between the main controller 102 and the sub-controller 105.

In step S504, the control unit 101 controls the power supply circuit and turns off the power of the sub-controller 105 and the wireless communication unit 103.

In step S505, the main controller 102 controls the communication switching unit 104 and performs switching processing so that the wireless communication unit 103 and the main controller 102 are connected. At this time, the sub-controller 105 and the wireless communication unit 103 are in a disconnected state.

In step S506, the control unit 101 causes the main controller 102 to transition to the still image mode, or starts the main controller 102 in the still image mode. When the main controller 102 transitions to the still image mode / is started in the still image mode, the control unit 101 changes the operation state of each part as necessary. For example, the control unit 101 changes the data format acquired from the imaging unit 106 or changes the UI or the video data format to be displayed on the display unit 107 as necessary.

In step S507, the control unit 101 determines whether or not the wireless communication function (wireless LAN function or BLE function) in the still image mode is enabled. If the control unit 101 determines that the wireless communication function is enabled, the process proceeds to step S508. On the other hand, if the control unit 101 determines that the wireless communication function is not enabled, the process returns to step S507 and re-determination is performed.

In step S508, the control unit 101 controls the power supply circuit and turns on the power of the wireless communication unit 103.

In step S509, the control unit 101 executes connection processing between the main controller 102 and the wireless communication unit 103. Thereafter, connection with a partner device is performed by a method defined by wireless LAN or BLE, and the wireless communication function can be used.

As described above, in the present embodiment, there are provided the main controller 102 that mainly performs imaging processing and communication processing of the imaging apparatus, and the sub-controller 105 that is different from the main controller 102 and performs communication processing. Further, there is provided the communication switching unit 104 (multiplexer) that switches a signal bus for controlling the wireless communication unit 103 (wireless module) between the main controller 102 and the sub-controller 105. The main controller 102 and the sub-controller 105 are connected by a signal bus, and have a configuration capable of inter-controller communication. Then, in the movie mode in which the processing load of the main controller 102 is high, the communication switching unit 104 (multiplexer) is controlled so as to connect the wireless communication unit 103 (wireless module) to the sub-controller 105. Thereby, configuration is such that the sub-controller 105 controls the wireless communication unit 103 (wireless module).

Further, in the still image mode in which the processing load is relatively small, the communication switching unit 104 (multiplexer) is controlled so as to connect the wireless communication unit 103 (wireless module) and the main controller 102. Then, the main controller 102 performs communication control of the wireless communication unit 103 (wireless module). At that time, the power of the sub-controller 105 may be turned off. Thereby, power consumption of the imaging apparatus 100 can be reduced.

On the other hand, in the movie mode in which the processing load is relatively large, the communication switching unit 104 (multiplexer) is controlled so as to connect the wireless communication unit 103 (wireless module) and the sub-controller 105. Then, the communication control of the wireless communication unit 103 (wireless module) that was being performed by the main controller 102 is performed by the sub-controller 105, and generation and processing of data transmitted and received by wireless communication are performed by the main controller 102. In this movie mode, it may be determined whether the wireless communication function of the imaging apparatus 100 is enabled or disabled, and if it is disabled, the power of the sub-controller 105 may be controlled to be off.

As described above, according to the present embodiment, even with a simple configuration in which the sub-controller and the multiplexer for selecting a connection destination controller of the wireless module are added, configuration is such that the sub-controller performs communication control of the wireless module according to the operation mode. Thereby, even in an operation mode in which the processing load of the main controller is large, the processing load due to wireless communication can be reduced. Therefore, the processing load of the controller can be reduced in an operation mode in which the processing load of the controller is high.

According to the present disclosure, in an operation mode in which the processing load of a controller is high, the processing load of the controller can be reduced.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

What is claimed is:

1. An imaging apparatus, comprising:
a wireless communication unit that communicates wirelessly with an external device; and
a switching unit that switches a controller that controls the wireless communication unit between a first controller and a second controller different from the first controller,
wherein the switching unit performs switching so as to connect the wireless communication unit and the first controller in a first mode, and to connect the wireless communication unit and the second controller in a second mode in which a processing load is larger than in the first mode.

2. The imaging apparatus according to claim 1,
wherein the switching is performed by the first controller controlling the switching unit.

3. The imaging apparatus according to claim 1,
wherein while the wireless communication unit and the second controller are connected, a connection between the wireless communication unit and the first controller is disconnected.

4. The imaging apparatus according to claim 1, wherein while the wireless communication unit and the first controller are connected, a connection between the wireless communication unit and the second controller is disconnected.

5. The imaging apparatus according to claim 1, further comprising a control unit that controls power of the second controller to be off in the first mode.

6. The imaging apparatus according to claim 1, further comprising:
a determination unit that determines whether a wireless communication function of the imaging apparatus is enabled or disabled; and
a control unit that, in a case where the wireless communication function of the imaging apparatus is determined by the determination unit to be disabled in the second mode, controls power of the second controller to be off.

7. The imaging apparatus according to claim 1, wherein while the wireless communication unit and the second controller are connected, the first controller performs communication with the second controller.

8. The imaging apparatus according to claim 1,
wherein the first controller is a controller for imaging processing and communication processing,
the second controller is a controller for communication processing,
in the first mode, the first controller executes imaging processing and communication processing, and
in the second mode, the first controller executes imaging processing, and the second controller executes communication processing.

9. The imaging apparatus according to claim 1, wherein a processing load of imaging processing performed by the first controller in the second mode is larger than a processing load of imaging processing performed by the first controller in the first mode.

10. The imaging apparatus according to claim 1,
wherein the first mode is a still image mode for shooting a still image, and
the second mode is a movie mode for shooting a movie.

11. The imaging apparatus according to claim 1,
wherein the first controller is a main controller,
the second controller is a sub-controller, and
the switching unit is a multiplexer.

12. The imaging apparatus according to claim 1,
wherein in the second mode, the second controller controls the wireless communication unit to perform communication using a wireless LAN function.

13. A method for controlling an imaging apparatus provided with a wireless communication unit that communicates wirelessly with an external device, the method comprising:
switching a controller that controls the wireless communication unit between a first controller and a second controller different from the first controller,
wherein in the switching, the wireless communication unit and the first controller are connected in a first mode, and switching is performed so as to connect the wireless communication unit and the second controller in a second mode in which a processing load is larger than in the first mode.

14. A non-transitory computer-readable storage medium storing a program for causing a computer to execute a method for controlling an imaging apparatus provided with a wireless communication unit that communicates wirelessly with an external device, the method comprising:
switching a controller that controls the wireless communication unit between a first controller and a second controller different from the first controller,
wherein in the switching, the wireless communication unit and the first controller are connected in a first mode, and switching is performed so as to connect the wireless communication unit and the second controller in a second mode in which a processing load is larger than in the first mode.
